(19) United States
(12) Patent Application Publication
(10) Pub. No.: US 2012/0141725 A1
(43) Pub. Date: Jun. 7, 2012

(54) Floor Mat

(76) Inventors: Yong Baik JUNG, Vernon, CA (US); Sung Jin BYUN, Vernon, CA (US)

(21) Appl. No.: 12/962,424

(22) Filed: Dec. 7, 2010

(51) Int. Cl. B32B 3/06

(52) U.S. Cl. 428/100

(57) ABSTRACT

A floor mat including a carpet portion, one or more hook-and-loop fastener portions, an anti-slip portion, and an edge portion is provided. The carpet portion is disposed on a top surface. The one or more hook-and-loop fastener portions are disposed on a bottom surface, each of which being corresponds to a counter fastener portion installed on a floor. The anti-slip portion is disposed on the bottom surface, comprising a plurality of bumps protruding downward from the bottom surface. The edge portion surrounds and secures the top and bottom surface. The bumps are disposed in a predetermined density and pattern. The carpet portion may comprise durable fabric.

### BACKGROUND OF THE INVENTION

The present invention relates to a floor mat for automobiles.

Inside a car, the floor is usually covered by mats for protecting the floor from being messed by debris coming in from outside.

The floor mat for automobiles must have a couple of features in order to perform the desired functions.

Firstly, the floor mat should be able to provide a surface for covering the floor. Secondly, the floor mat must stick to the floor securely so as to stay at a predetermined location on the floor.

Conventional floor mats were proposed, but it was challenging to find a floor mat which satisfies the requirements.

Accordingly, a need for a floor mat has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a floor mat.

The floor mat comprises a carpet portion, one or more hook-and-loop fastener portions, an anti-slip portion, and an edge portion.

The carpet portion is disposed on a top surface.

The one or more hook-and-loop fastener portions are disposed on a bottom surface, each of which being corresponds to a counter fastener portion installed on a floor.

The anti-slip portion is disposed on the bottom surface, comprising a plurality of bumps protruding downward from the bottom surface.

The edge portion surrounds and secures the top and bottom surface.

The plurality of bumps are disposed in a predetermined density and pattern.

The carpet portion may comprise durable fabric.

The top and bottom surfaces may have a predetermined shape, and the predetermined shape may comprise a plurality of corner portions, side portions, and central portions.

The one or more hook-and-loop fastener portions may be disposed on the plurality of corner portions of the bottom surface.

The anti-slip portion may be provided on the plurality of side portions of the bottom surface.

The anti-slip portion may be provided on the plurality of central portions of the bottom surface.

The one or more hook-and-loop fastener portions may be disposed on the plurality of corner portions and along the plurality of side portions of the bottom surface.

The hook-and-loop fastener portions may be disposed along the plurality of corner portions and side portions of the bottom surface, so as to enclose the central portion of the bottom surface completely.

The hook-and-loop fastener portions may be disposed on the central portion of the bottom surface.

The predetermined shape may comprise one or more rectangles.

The predetermined shape may further comprise one or more circular edge portions.

Each of the plurality of bumps of the anti-slip portion may have a shape of cone.

Each of the plurality of bumps of the anti-slip portion may have a shape of pyramid.

The advantages of the present invention are: (1) the floor mat is easy to install; and (2) the floor mat according to the invention enables secure fixing to the floor.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective top view showing a car installed with floor mats according to an embodiments of the invention;

FIG. 2 is a perspective top and partially bottom views showing a floor mat according to an embodiments of the invention;

FIG. 3 is a perspective bottom view showing of the floor mat of FIG. 2; and

FIG. 4 is a cross-sectional view showing a bump in a anti-slip portion according to an embodiment of the invention.

### DETAILED DESCRIPTION EMBODIMENTS OF THE INVENTION

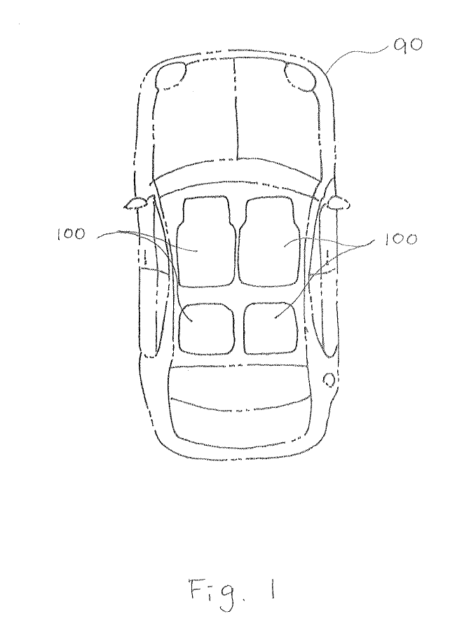

FIGS. 1-5 show a floor mat according to an embodiment of the invention.

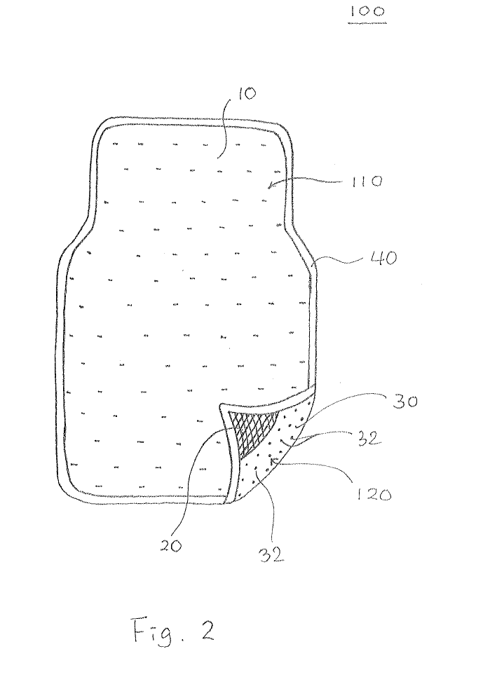

The floor mat 100 is usually installed on a floor of car 90 as shown in FIG. 1. The floor mat 100 comprises a carpet portion 10, one or more hook-and-loop fastener portions 20, an anti-slip portion 30, and an edge portion 40 as shown in FIG. 2.

The carpet portion 10 is disposed on a top surface 110 of the floor mat 100.

The one or more hook-and-loop fastener portions 20 are disposed on a bottom surface 120 of the floor mat 100, each of which being corresponds to a counter fastener portion installed on the of the floor mat 100. That is, a hook fastener portion may be on the floor mat 100, and the counter fastener portion, a loop fastener portion may be disposed on the floor mat 100.

The anti-slip portion 30 is disposed on the bottom surface 120, comprising a plurality of bumps 32 protruding downward from the bottom surface 120.

The edge portion 40 surrounds and secures the top and bottom surfaces 110, 120. In an embodiment, the edge portion 40 may comprises a fabric portion and the fabric portion may be formed by sewing or gluing.

The plurality of bumps 32 are disposed in a predetermined density and pattern. The purpose of the plurality of bumps 32 are to prevent the floor mat 100 from being slipped over the floor of the car 90. Therefore, the density and pattern of the plurality of bumps 32 may be determined to maximize the friction between the bottom surface 120 and the floor of the car 90.

The carpet portion 10 may comprise durable fabric. In certain embodiments of the invention, the carpet portion 10 may be a regular carpet in a living room.

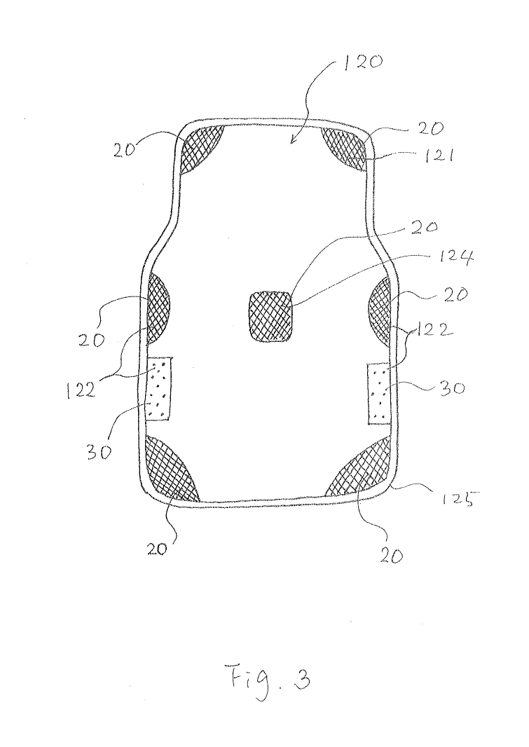

The top and bottom surfaces 110, 120 may have a predetermined shape, and the predetermined shape may comprise a plurality of corner portions 121, side portions 122, and central portions 124 as shown in FIGS. 2 and 3.

The one or more hook-and-loop fastener portions 20 may be disposed on the plurality of corner portions 121 of the bottom surface 120 as shown in FIGS. 2 and 3. The anti-slip portion 30 may be provided on the plurality of side portions 122 of the bottom surface 120.

The anti-slip portion 30 may be provided on the plurality of central portions 124 of the bottom surface 120.

The one or more hook-and-loop fastener portions 20 may be disposed on the plurality of corner portions 121 and along the plurality of side portions 122 of the bottom surface 120.

The hook-and-loop fastener portions 20 may be disposed along the plurality of corner portions 121 and side portions 122 of the bottom surface 120, so as to enclose the central portion 124 of the bottom surface 120 completely.

The hook-and-loop fastener portions 20 may be disposed on the central portion 124 of the bottom surface 120.

The predetermined shape may comprise one or more rectangles as shown in FIG. 1.

The predetermined shape may further comprise one or more circular edge portions 125 as shown in FIG. 3.

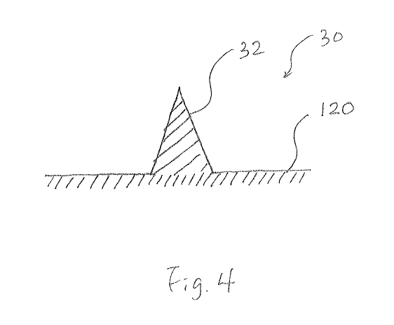

Each of the plurality of bumps 32 of the anti-slip portion 30 may have a shape of cone as shown in FIG. 4.

Each of the plurality of bumps 32 of the anti-slip portion 30 may have a shape of pyramid (not shown).

In certain embodiment of the invention, the hook-and-loop fastener portions 20 may comprise another types of fastening surface such as a plurality of thumbtacks.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A floor mat comprising:
a carpet portion disposed on a top surface;
one or more hook-and-loop fastener portions disposed on a bottom surface, each of which being corresponds to a counter fastener portion installed on a floor;
an anti-slip portion disposed on the bottom surface, comprising a plurality of bumps protruding downward from the bottom surface; and
an edge portion surrounding and securing the top and bottom surface,
wherein the plurality of bumps are disposed in a predetermined density and pattern.

2. The floor mat of claim 1, wherein the carpet portion comprises durable fabric.

3. The floor mat of claim 1, wherein the top and bottom surfaces have a predetermined shape, and wherein the predetermined shape comprises a plurality of corner portions, side portions, and central portions.

4. The floor mat of claim 3, wherein the one or more hook-and-loop fastener portions are disposed on the plurality of corner portions of the bottom surface.

5. The floor mat of claim 4, wherein the anti-slip portion is provided on the plurality of side portions of the bottom surface.

6. The floor mat of claim 5, wherein the anti-slip portion is provided on the plurality of central portions of the bottom surface.

7. The floor mat of claim 3, wherein the one or more hook-and-loop fastener portions are disposed on the plurality of corner portions and along the plurality of side portions of the bottom surface.

8. The floor mat of claim 7, wherein the hook-and-loop fastener portions are disposed along the plurality of corner portions and side portions of the bottom surface, so as to enclose the central portion of the bottom surface completely.

9. The floor mat of claim 7, wherein the hook-and-loop fastener portions are disposed on the central portion of the bottom surface.

10. The floor mat of claim 3, wherein the predetermined shape comprises one or more rectangles.

11. The floor mat of claim 10, wherein the predetermined shape further comprises one or more circular edge portions.

12. The floor mat of claim 1, wherein each of the plurality of bumps of the anti-slip portion has a shape of cone.

13. The floor mat of claim 12, wherein each of the plurality of bumps of the anti-slip portion has a shape of pyramid.
